(19) United States
(12) Patent Application Publication
(10) Pub. No.: US 2024/0160161 A1
(43) Pub. Date: May 16, 2024

(54) CHEMICAL PROCESS MODELING

(71) Applicant: BASF SE, Ludwigshafen am Rhein (DE)

(72) Inventors: Satya Swarup SAMAL, Ludwigshafen am Rhein (DE); Hayder SCHNEIDER, Ludwigshafen am Rhein (DE); Robert PACK, Ludwigshafen am Rhein (DE)

(21) Appl. No.: 18/282,296

(22) PCT Filed: Mar. 11, 2022
(86) PCT No.: PCT/EP22/56297

§ 371 Date: Sep. 15, 2023

(30) Foreign Application Priority Data
Mar. 15, 2021 (EP) 21162641.1

(51) Int. Cl. G05B 13/04; G05B 13/02

(52) U.S. Cl. CPC G05B 13/042; G05B 13/0265

(57) ABSTRACT

The present teachings relate to a method for modeling an industrial plant comprising a plurality of equipment, the method comprising: providing a plant level model of the industrial plant; wherein the plant level model has been generated via a topology generator by automatically selecting and interconnecting equipment models from a model library; obtaining, using a model trainer, a trained plant level model; wherein the trained plant level model is obtained from the plant level model by training at least some of the equipment models in the plant level model using one or more historical datasets; wherein the trained plant level model is usable for computing at least one performance parameter via a model executor. The present teachings also relate to a framework, a software product, a use of the model and a use of the performance parameter.

### TECHNICAL FIELD

The present teachings relate generally to computer assisted chemical processing and/or modeling.

### BACKGROUND ART

In industrial plants, input material is processed using one or more equipment to obtain one or more products. Properties of the processed or manufactured product thus have a dependence upon process parameters. It is usually desired to correlate process parameters to at least some properties of the product for ensuring product quality or production stability.

Within process industry, or industrial plants such as chemical or biological production plants, mathematical models based on process conditions can be helpful in the design of equipment, improvement of the processed or manufactured products (e.g. quality, conversion) as well as predicting the unforeseen outages or interruptions in the industrial plants in order to undertake maintenance activities in a planned manner. However, the production environment in the process industry can be complex, accordingly the properties of the product may vary according to variations in the production parameters that influence said properties.

In some production processes, catalyst may be used. The behavior or properties of the catalyst may also change over time and usage. Hence, the dependency of the properties on production or process parameters can be complex and intertwined with a further dependence on one or more combinations of specific parameters. In some cases, the production process may be divided into multiple stages, which can further aggravate the problem. It may thus be challenging to produce a chemical or biological product with consistent and/or predictable quality. Moreover, state of the equipment or catalyst may also be important to determine for maintenance and/or replenishment. Such time dependent equipment behavior can add another dimension of complexity in the chemical production or processing environment. In industrial plants such as chemical plants, the requirements of safety and sustainability can be especially high.

Sometimes, one or more performance parameters are determined via computerized modeling of the production process, product, or equipment. Such performance parameters can be used for determining or predicting performance of the respective product, equipment, or plant. This however may not be a straightforward task. Expert knowledge may be required to set up a model that is suitable for the purpose. Additional aspects that may be required to be solved can include one or more of: model storage, integration, and deployment. This may present as a substantial roadblock in usage of modeling for improving industrial production or processing, more specifically at a chemical plant.

There is hence a need for method and system that can simplify the computation of performance parameters by the addressing the above challenges, which in turn can be usable for improving quality and production stability in industrial plants.

### SUMMARY

At least some of the problems inherent to the prior art will be shown solved by the subject matter of the accompanying independent claims. At least some of the further advantageous alternatives will be outlined in the dependent claims.

When viewed from a first perspective, there can be provided a computer-implemented method for modeling an industrial plant, said industrial plant comprising a plurality of equipment, wherein the method comprises:
providing a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtaining, using a model trainer, a trained plant level model; wherein the trained plant level model is obtained by training at least some of the equipment models in the plant level model using one or more historical datasets;
wherein the trained plant level model is usable for computing at least one performance parameter via a model executor, the at least one performance parameter being related to the industrial plant.

Hence, according to an aspect, the method also comprises:
computing, via the model executor, the at least one performance parameter using the trained plant level model.

In other words, there can be provided a computer-implemented method for computing at least one performance parameter related to an industrial plant, said industrial plant comprising a plurality of equipment, wherein the method comprises:
providing a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtaining, using a model trainer, a trained plant level model; wherein the trained plant level model is obtained by training at least some of the equipment models in the plant level model using one or more historical datasets;
computing, via a model executor, at least one performance parameter using the trained plant level model.

“Performance parameter” may be, or it may be indicative of, any one or more properties of a chemical product, industrial plant, or equipment.

Accordingly, in case of a product, the performance parameter may be such a parameter that should satisfy one or more predefined criteria indicating suitability, or a degree of suitability, of the chemical product for a particular application or use. It will be appreciated that in certain cases, the performance parameter may indicate a lack of suitability, or a degree of unsuitability, for a particular application or use of the chemical product. As non-limiting examples, the performance parameter may be any one or more of, strength such as tensile strength, color, concentration, composition, viscosity, stiffness such as Young's modulus value, purity or impurity such as parts per million (“ppm”) value, failure rate such as mean time to failure (“MTTF”), or any one or more values or value ranges, for example determined via tests using a predefined criteria. The performance parameter may thus be representative of the performance or quality of the chemical product. The predefined criteria may, for example, be one or more reference values or ranges with respect to which the performance parameter of the chemical product is compared to, for determining the quality or performance of the chemical product. The predefined criteria may have been determined using one or more tests, thus defining the requirements on the performance parameter for the chemical product to be suitable for one or more particular uses or applications.

In case of the industrial plant or equipment, the performance parameter may be such a parameter that indicates a state of the industrial plant or equipment. The state, or at least in some cases even the performance parameter, may be indicative of suitability, or a degree of suitability, of the industrial plant or equipment for performing a particular task or process. As some non-limiting examples, the state may be any one or more of: efficiency of a process, throughput of processing or production, fouling in a boiler, degradation of a catalyst, time to maintenance, quality criterion prediction, etc.

The applicant has realized that building a deployable computer model in an industrial plant comprising a plurality of equipment can not only be time consuming, but also require a high degree of expertise. For example, for a plant level model to be deployed for an industrial plant, at least some of the challenges mentioned that were mentioned previously may be needed to be addressed. The present teachings thus disclose a system that can not only at least partially automatically build a plant level model, but also leverage historical data to build a model that is representative of a specific state of the industrial plant such that the at least one performance parameter related to the industrial plant can be more reliably and accurately computed. For safety critical plants and plants having complex processing of production chains, for example industrial plants such as chemical, biological or process plants the present teachings can provide a way to seamlessly build, deploy and evaluate performance parameters dynamically. Thus, the performance parameters as generated using the present teachings can synergistically leverage plant data via the one or more historical datasets, such that relevance of such performance parameters can be high in context not only of the industrial plant, but also the processing or production process for which such parameters need to be computed. Thus, production processes can be improved without requiring expert users for building or deploying such models. Especially for chemical plants, this can improve safety and/or sustainability of production. It will further be appreciated that the present teachings can allow at least some of the models in model library to be automatically reused by being selected via the topology generator, thus further reducing the technical effort of building and/or deploying the trained plant level model which is usable for computing the at least one performance parameter. Similarly, any new or improved models can be fed to the model library thus enriching the model library for further enhanced reusability and reduction of technical effort in building and/or deploying future trained plant level models.

It will also be appreciated that in cases when at least some of the equipment of the industrial plant is used in different scenarios, the same trained plant level model, or even the same plant level model, may not be suitable for use in the different scenarios. In other words, in different scenarios such as processing or production of different products, the same model may not be suitable. The present teachings, for example, via automatic selection and interconnection of relevant models can essentially on-the-fly build the plant level model and trained plant level model by leveraging the relevant data such that the resulting trained plant level model is suitable for computing at least one performance parameter which is relevant for the given scenario.

Those skilled in the art will appreciate that development of a computer model, especially having high quality for more accurately predicting the performance can be a resource intensive task. Additionally, process modeling may be done at different abstraction levels. Further additionally, in some cases the same equipment or plant may need to be configured for a different operating mode or scenario, for example, for processing or producing a different product, further complicating a correct deployment of models that are required for modeling the given scenario. The model library as proposes thus provides a well-defined model storage where various models such as the equipment models are pooled. The model library can thus enhance the reusability and even transferability of the models for different scenarios.

By adding metadata to at least some of the models in the model library, these aspects can be further enhanced. In particular, by using metadata, the best fitting model from a model library can be selected. In this way, the trained plant level model yields the most reliable results, so it can monitor and/or control the industrial plant more accurately. Metadata can comprise the type of equipment the model relates to, for example a distillation column or spray coater, the process the model relates to, for example grinding or packaging, or reagents or products the model relates to, for example demineralized water or adhesive tapes. Metadata may further comprise the dimensions of the equipment, the geographical location the equipment is used, the type of industrial plant in which the equipment is used, the manufacturer of the equipment or specifications of the equipment, for example a temperature or pressure range within which the equipment can be operated.

Preferably, the metadata is structured by an ontology to facilitate using the best fitting model. Ontology typically involves description of generic concepts, axioms or constraints on the concepts along with its relations for a target domain, for example chemical process modeling. An example has been published by J. Morbach et al. in Engineering Applications of Artificial Intelligence, volume 20 (2007), pages 147-161. The ontology can be organized by means of three types of structural elements: layers, modules, and partial models. Layers subdivide the ontology into levels of abstraction, thus separating general knowledge from knowledge about particular domains and applications. Modules assemble a number of elements that cover a common topic as well as the relations describing the interactions between the elements and the constraints defined on them. Modules that address closely related topics can be grouped into partial models. The partial models may constitute a coarse categorization of the domain. Unlike modules, partial models may stretch across several layers.

Furthermore, the model library can improve the collaboration among modelers as well as model governance. “Model governance” encompasses one or more actions or sequence of events leading to the inclusion of a model in the model library. Such actions may include versioning, training data, scoring metrics, user approval, aspects on reproducibility, definition of inputs/outputs, compliance e.g., with organization and/or legal aspects. Such aspects may be specified as model metadata and can be provided or linked to the model library, preferably together with the respective model.

It shall also be appreciated that presence of multiple processes and/or equipment in an industrial plant can lead to several heterogenous models each or some may even have dependency on the plant topology, or even the context in which the respective model was used, or is developed for. Thus, an integration (or combination) of such models may be required when they are reused. Furthermore, several kinds of models describing the same process may be available, e.g. differing in their abstraction, accuracies and data demand. Therefore, the present teachings can provide a systematic way of representing the plant topology as well as selecting models from the model library as per requirements. Thus, the plant level model can be generated whilst optimizing an integrated set of models that are used to build the plant level model. With regards to model deployment, the present teachings can allow taking into account or monitoring the performance of the model in a real-time manner. This can be especially beneficial for retraining or decommissioning the model, for example, if the model performance drifts from the acceptable limits.

Here, monitoring of model means tracking the various model performances of a deployed model via a monitoring logic that is provided at least a part of real-time process data. This monitoring includes but not limited to model accuracy, model execution time, CPU load of the model, statistical property of the input data to the model (e.g. mean, standard deviation, statistical distributions), variable types of input data. This has a benefit that due to changes in the plant, for example, change, addition of new equipment or removal, change of sensor types, change in the operations, dynamic market or demand scenarios can cause a deviation between the historical data based on which the model had been trained and the realtime data, thus affecting the model accuracy. In such a case, the model may need to be retrained or if the data demand doesn't match the requirements in task meta-data, the model may have to be decommissioned. The present teachings such detection and thus prevent outdated models from being deployed.

According to an aspect, the plant topology is represented via the plant level model that is at least partially implemented as a computerized graph structure. The nodes of the graph may represent either an equipment model and/or an effect model. The edges of the graph may depict the interactions among the models. For example, the edges may represent physical connections between two or more equipment models (e.g. transport medium such as mechanical pipes) or an interaction between two or more effect models, or between at least one effect model and at least one equipment model.

The graph may be provided in any manner, preferably, automatically via the topology generator. As a few non-limiting examples, the graph may be provided using a topological representation of the plant, for example, in a computer readable format, or it may be provided in a semi-automated manner, for example, in response to input from a user.

As a further non-limiting example, one of the equipment models is a catalytic reactor model and one of the effect models is a time-dependent aging phenomenon of the catalyst that is provided in the catalytic reactor. Pursuant to the previous example, this configuration may be represented via a graph structure comprising two nodes i.e., a reactor equipment model node and a catalyst deactivation node. It shall be clear that the nodes are representative of the catalytic reactor and the time-dependent aging. There can be provided an edge between these two nodes that represents the interaction or activity of the catalyst from the effect model, for example, an output of the effect model which has an effect on the behavior of the reactor model. The applicant has found the present teachings particularly suitable for detecting catalyst deactivation in catalytic reactors such that catalyst efficiency and/or lifetime can be enhanced. However, it shall be clear to those skilled in the art that the present teachings can be applied to a wider family of chemical processes or even industrial processes still retaining at least some of the general benefits that the present teachings can provide.

Further as a non-limiting example, in modeling catalyst deactivation within a reactor, two models namely, an equipment model of the reactor and an effect model of deactivation process may be used. Inputs to the equipment model may be the plant process conditions (e.g. one or more of: mass fractions, temperature, pressure) and activity factor. The output of the trained plant level model may be at least one performance parameter of the final product, and/or catalyst performance. For the effect model, the inputs may be the process conditions provided via real-time process data, and activity factor. The topology generator by looking at this input/output mapping may automatically combine the two models such the output of effect model is linked to the input of the equipment model.

Those skilled in the art shall appreciate that the method steps may be implemented via a single computing unit or via a plurality of computing units. Hence, any of the method steps may be performed via any one or more of the computing units either at the same location or at different locations, for example, as a distributed system or a cloud-based service.

When viewed from another perspective, there can also be provided a computer-implemented method for computing at least one performance parameter related to an industrial plant, said industrial plant comprising a plurality of equipment, wherein the method comprises:
providing a model library comprising computer readable equipment models for at least some of the equipment;
generating, via a topology generator, a plant level model of the industrial plant by selecting and interconnecting equipment models from the model library; the plant level model being a topology representation of the industrial plant;
training, via a model trainer, at least some of the equipment models in the plant level model; wherein the training is performed using one or more historical datasets,
computing, via a model executor, the at least one performance parameter using the trained plant level model.

It will be appreciated that the plant level model is a computer-readable model. The plant level model may be provided at any of the computing units configured to implement the method steps and/or at a memory storage or location operatively coupled to the computing unit. The plant level model may even be provided by receiving via another computing unit and/or it may be processed via any of the computing units. The plant level model may even be provided by being generated via the same computing unit, for example the computing unit executing the topology generator.

The topology representation of the industrial plant may either be the entire representation of the industrial plant, or it may be a partial representation of the industrial plant. As the industrial plant may be configured for processing or producing different products are different times, the topology representation is indicative of, or related to, the process or task the industrial plant is configured to perform. Accordingly, at least some of the equipment models and/or effect models selected via the topology generator may be different dependent upon the specific process that is to be undertaken at the industrial plant, for example production of a specific chemical product.

“Model library” refers to a digital library or database of models. The models may be equipment models, i.e., those related to equipment. The models may even include those related to process units of the industrial plant.

According to an aspect, some or each of the models are provided their respective task metadata. The task metadata of a model may include at least one selection criterion. The task metadata may be used by the topology generator for selecting the respective model, for example, based on the selection criterion.

The model library may be a database comprising flowsheet and/or mechanistic models for the equipment and/or mechanistic models for effects including any one or more of: chemical reaction, thermodynamics, chemical kinetics, operational effects, such as quality variance, or degradation. The models which are mechanistic models may be equipment models and/or at least one of them may be an effect model. Thus, besides equipment models, the model library may include one or more effect models related to any one or more of: chemical reaction, thermodynamics, chemical kinetics, operational effects, such as quality variance, or degradation.

“Mechanistic models” refers to those models which are based on the fundamental laws of natural sciences, for example any one or more of, physical, chemical, biochemical principies, heat and mass balancing. Such models thus represent these principles using equations. A few non-limiting examples of such equations are, ordinary differential equations (“ODEs”), differential algebraic equations (“DAEs”), algebraic equations (“AEs”), or any of their combinations. A flowsheet model may incorporate a plurality of mechanistic models. For the sake of simplicity and without any loss of generality, the flowsheet model will also be referred to as a mechanistic model in the present disclosure. Additionally, or alternatively, the model library comprises, for any of the model types, at least one surrogate model, for example a data-driven model. Thus, the model library may comprise pre-trained and/or untrained data-driven models. In other words, the model library may comprise purely mechanistic models for one or more of the equipment and/or effects, i.e., at least one purely mechanistic equipment model and/or at least one purely mechanistic effect model.

Additionally, or alternatively, the model library my comprise purely data-driven models, pretrained or untrained, for any one or more of the equipment and/or effects. In other words, the model library may comprise at least one purely data-driven equipment model and/or at least one data-driven mechanistic effect model. Hence, it will be understood that the model library may include not only white-box models, but also at least one grey-box model and/or at least one black-box model. In some cases, one or more equipment models may even comprise one or more effect models.

More generally, the model library thus comprises models or functions, each of which maps respective input features to a respective output space via one or more pre-defined tasks. In other words, for a given task or process, there may be at least one model that maps a set of inputs to one or more outputs via one or more equations—fundamental and/or statistical.

“Data-driven model” refers to refers to a model that is at least partially derived from data. In contrast to a rigorous model that is purely derived using physio-chemical laws, a datadriven model can allow describing relations that cannot be modelled by physio-chemical laws. The use of data-driven models can allow to describe relations without solving equations from physio-chemical laws. This can reduce computational power and/or improve speed.

The data-driven model may be a regression model. The data-driven model may be a mathematical model. The mathematical model may describe the relation between provided properties and determined properties as a function. Properties in this context may be performance properties or behavior properties, represented by one or more parameters that can change over use or time, for example, performance or behavior of an equipment that can change based on how long the equipment is used. Similarly, the property may even be a material property, for example, behavior of a catalyst or a chemical product. As some nonlimiting examples, the data-driven model may be based on any one or more of, artificial neural network (“ANN”), support-vector machine (“SVM”) and their likes.

Thus, in the present context, the data-driven model, preferably data-driven machine learning (“ML”) model or a merely data-driven model, refers to a trained mathematical model that is parametrized according to the respective training data set, such as historical process data from the plant or equipment, to reflect reaction kinetics or physio-chemical processes related to the plant and/or one or more equipment and/or material. An untrained mathematical model refers to a model that does not reflect reaction kinetics or physiochemical processes, e.g. the untrained mathematical model is not derived from physical law providing a scientific generalization based upon empirical observation. Hence, the kinetic or physio-chemical properties may not be inherent to the untrained mathematical model. The untrained model does not reflect such properties. Feature engineering and training with the respective training data sets enable parametrization of the untrained mathematical model. The result of such training is a merely data-driven model, preferably datadriven ML model, which as a result of the training process, preferably solely as a result of the training process, reflects reaction kinetics or physio-chemical processes related to the respective plant and/or one or more of the plant's equipment or assets and/or materials.

“Equipment model” refers to a model, mechanistic and/or surrogate, for an equipment related to the industrial plant.

“Effect model” refers to a model, mechanistic and/or surrogate, for one or more physiochemical effects or processes.

“Plant level model” refers to a model which is aggregated by selecting a plurality of equipment models from the model library. The plant level model may also include at least one effect model. The selection is made via the topology generator. The trained plant level model is based upon the plant level model, the former being a model in which the at least one training operation has been performed either for at least one equipment model and/or at least one effect model. The plant level model may have a plurality of trainable parameters which are trained using training data. Thus, values of said trainable parameters are set via the training data.

“Topology generator” refers to a module or logic which generates or builds the plant level model by selecting models from the model library. The selection of the models from the model library may be performed in response to an input or in response to information about the process for which the plant level model is to be built. The input may for example be a user input, such as one or more keywords. According to an aspect, the topology generator uses a similarity score for selecting at least one of the models. The similarity score may be computed based upon scenarios such as tasks or processes for which a given model was used or generated prior to being selected via the topology generator for providing the plant level model.

The similarity score may also be based on the metadata associated to each model in the model library. Hence, the topology generator may use information from the topology model and compare them with the metadata of the models in the model library. For example, if the topology model contains as a piece of equipment a distillation column, the topology generator may assign all models in the model library a high similarity score if its metadata contains or is related to the concept of a distillation column.

Metadata may be structured by an ontology. In this case the similarity score may be determined based on semantic similarity. Semantic similarity can be computed based on the closeness of two concepts contained in the ontology. The semantic similarity can be numerically represented through a distance metric. Based on the numerical value of the distance metric, closeness between the concepts can be determined or a search based on related concepts can be performed.

“Trained plant level model” refers to a model which does not require training at least in the near future for computing the at least performance parameter. The trained plant level model is hence such a model which is ready to be used for computing the performance parameter. The trained plant level model may be obtained by training at least some of the models in the plant level model. The models which are trained may be equipment models and/or at least one of the models may be an effect model. The trained plant level model may be obtained either after providing or generating the plant level model or the trained plant level model may be obtained simultaneously as the plant level model by building the plant level model using pre-trained models, e.g., at least one pre-trained model. Additionally, or alternatively, at least one of the models may be trained prior to obtaining the trained plant level model. It will thus be appreciated that the method steps may be performed in different sequences.

“Model trainer” refers to a module or logic that trains at least one of the equipment models and/or effect model related to the plant level model. The training operation may be performed using one or more historical datasets. The model trainer may be configured to automatically select the one or more historical datasets in response to the one or more keywords provided via a user input and/or the similarity score. The model trainer may be a part of the topology generator or it may be a different module. According to an aspect, the model trainer utilizes an optimizer logic for computing optimal values of at least some of the trainable parameters of the plant level model. The optimal values may be such for which the difference between an output of the trained plant level model and the corresponding actual signal is minimized. Thus, the optimizer is finds values of such trainable parameters such that the model output matches with its corresponding actual real-life signal. The optimizer logic may involve local and/or global optimization techniques. Additionally, or alternatively, and the optimizer logic may use one or more derivate-free optimization techniques, or it may use derivate or gradient based optimization techniques. An advantage of derivatefree optimization techniques is that they can be used to optimize effect or equipment models for which derivate computation is infeasible (e.g. non-smooth functions) or it is time consuming to determine the derivates. An advantage of derivative computation is faster convergence of the optimizer to the optimal values of the trainable parameters. Additionally, or alternatively, based on the availability of the historical datasets and/or corresponding model of given complexity or abstraction level and/or deployment requirements and/or required model performance metrics, different version of the same process might be chosen. The topology generator may leverage the task metadata for this purpose. For example, a given scenario or process in the plant level model may be modeled using either a mechanistic model or a data-driven model or a grey-box model or even suitable combinations of these models. Based on the nature of historical data that is available and the task metadata, selection of one of these models may be preferred by the topology generator. For example, in case of a reactor equipment, the mechanistic equipment model might have a smaller data demand as compared to a data-driven equipment model of the same reactor equipment. Based on the amount and/or quality of the historical data for model training, the topology generator may select the model type that is better suited.

“Model executor” refers to a module or logic which can use the trained plant level model for computing the at least one performance parameter. The model executor may hence be a software module that is executed via one or more computing units, or the model executor may even refer to a hardware unit or a combination of hardware units comprising one or more computing units which are configured to execute the model executor software module or logic. For computing the at least one performance parameter, the model executor may be provided at least a subset of real-time process data. Such real-time process data may be sensor data from the industrial plant, wherein the sensor data is recorded by the sensors in the industrial plant and transferred to the model executor within a short time period, for example less than ten seconds, or less than a second. According to an aspect, the model executor comprises the model monitoring logic, which monitors model performance based on one or more scoring metrics, for example user selected metrics. For this purpose, a difference in the performance parameter computed by the trained plant level model and the actual or real-time plant data may be quantified using numerical scores or scoring metrics. The scoring metrics may include one or more of: accuracy, R\hat{ }2 fit, computational resource usage such as memory consumption, execution time, uncertainty in model predictions for example, exemplified through the confidence intervals of the predicted performance parameter. The deviation of these metrics from a predefined limit may alert the model executor or the model trainer and/or the user thereby prompting to automatically retrain the model with new data or decommissioning the plant level model. The deviation may be a result of, for example, data drift and/or concept drift. The concept or data drift can sometimes be caused if the underlying chemical processes or changes are made to the industrial plants, for example, change of the sensors which generate the data. Such a change can change the statistical properties of the real-time data with respect to the historical data for which the model has been initially trained. Thus, pursuant to the present teachings such a change can be detected and addressed either via retraining or decommissioning the plant level model. This can improve reliability of the deployed models in the industrial environment.

As it was discussed, the model selection from the model library may be performed in response to an input or in response to information about the scenario. The input may for example be a user input, such as one or more keywords. The input may even be in the form of a process layout and/or from a digital piping and instrumentation diagram (“P&ID”) and/or defined by the user. According to an aspect the digital P&ID input is obtained via a memory storage or database and/or via parsing an image file and/or a portable document format (“PDF”) file. Additionally, or alternatively, the input may include data related to equipment design, location, layout or connections between two or more equipment. Additionally, or alternatively, the input may include data related to one or more sensors, such as location, type, and measurement uncertainty. Additionally, or alternatively, the input may include data related to one or more chemical processes, for example, process type, reactants, product streams, range of operation such as temperature, dosing, pressure, and mass flow rates. Additionally, or alternatively, in case of the process at the industrial plant involves one or more catalytic processes, the input may include data related to one or more catalysts: such as catalyst geometry and support material.

According to an aspect, the topology generator uses at least one similarity score for selecting at least one of the models. The similarity score may be determined from the selection criterion or criteria. According to an aspect, the selection is performed in response to a comparison between the input and the task metadata of a model. The comparison may be a text mining operation, which for example determines model capability from the task metadata. The task metadata may even be in the form of one or more tags. A few non-limiting examples of the model capability or features are: mass balance, reaction and distillation. Additionally, or alternatively, the task metadata may comprise one or more model requirements, for example, minimum input signals, number of outputs, etc. Additionally, or alternatively, the similarity score or measure may be computed via a text similarity or natural language processing (“NLP”) algorithm. Additionally, or alternatively, the similarity score may be computed using one or more complex graph structures and/or isomorphism algorithms. Additionally, or alternatively, the similarity score may be computed using Euclidian distances, for example, for determining model validity for a particular scenario. Additionally, or alternatively, the task metadata comprises quality criterion score and/or goodness of fit score of the respective model to a particular one or more: process or process type, process unit, or industrial plant. Additionally, or alternatively, the task metadata comprises any one or more of: model version, staging information i.e., whether the respective model is under development or is or has been deployed in any pre-existing plant level model, data instances used to train the model quantifying the data demand, sensitivity of the model outputs with respect to model input quantifying model robustness, model complexity e.g., as quantified by number of trainable parameters, ease of deployment expressed in a quantifiable manner such as a score and/or deployment time.

According to an aspect, the model trainer determines a training method for at least one of the selected models. The determination of the training method may be made based on plant topology determined via the plant level model and/or input.

Additionally, or alternatively, the model trainer selects at least one of the historical datasets for training in response to a topology context score and/or the task metadata. The topology context score may be appended to the respective historical dataset, such that said dataset is selected based upon a comparison between the respective topology context score and the task metadata of the respective model. This can have an advantage that when new or improved data is available, then subset of relevant models can be determined, e.g., for retraining purposes by matching the topology context score with the task metadata of respective models. The trained plant level models can thus be provided faster and whilst ensuring that the best dataset is leveraged for the computation of the at least one performance parameter.

“Historical dataset” refers to a dataset comprising historical data which is used for training one or more models. The dataset may comprise time-series data, for example, related to one or more equipment. The time-series data may comprise one or more signals, for example, those from one or more sensors and/or controller setpoints and/or controller outputs. The historical dataset may even comprise one or more time-series signals from so-called one or more “soft sensors”, which represent signals that have been generated without direct measurements. Soft-sensor signals are obtained by processing a plurality of signals from the time-series data by applying one or more computational functions to said signals. Some soft-sensor signals may even be computed in response to one or more inputs from other soft-sensors. A non-limiting example of soft-sensor outputs is: efficiency signal calculated based on temperature and flow values. As it will be appreciated, the efficiency signal can be a time-dependent signal or time-series signal which is calculated by applying a certain mathematical relationship to the temperature and flow values. Since such an “efficiency sensor” is not implemented as a physical sensor that measures efficiency, it can be termed as a soft-sensor. The soft-sensor data may be computed in real-time in response to the time-dependent inputs to the soft-sensor, or the soft-sensor data may be computed from stored data from the past. The time-series of the various signals may or may not differ in terms of sampling frequency. For example, the data from the offline laboratory tests may have a low sampling frequency as compared to the sampling frequency of online sensors in the field.

The trained plant level model may be retrained from time to time to adjust it even better to the industrial plant. For this purpose, the model trainer may add sensor data and/or analytics data to the historical dataset and start the model training from the plant level model again. This approach is likely to yield a well fit model, however, it may be computationally expensive and may require stopping the model executor for a while. To avoid such stops, the trained plant level model may be retrained with only new datasets obtained from the sensors and/or analytical data from the industrial plant. This approach needs less computational power and hence finishes faster. However, it involves the risk that the trained plant level model “forgets” the historic dataset it was originally trained for. This effect is sometimes also referred to as catastrophic interference or catastrophic forgetting. In cases where the historic datasets are only available for similar, but not identical industrial plant, this effect may be acceptable. However, often one wants to avoid such forgetting. There are various ways of to run retraining while lowering the impact of forgetting the historic datasets: The retraining may only allow small changes, for example by punishing large changes in the cost or loss function which is minimized during the retraining process. Alternatively, certain parts of the model may not be subject to any changes, for example if it has turned out that this part of the model yields results with high or sufficiently high accuracy.

As it will be appreciated, the present teachings can provide a more flexible and reusable way for monitoring and/or optimization of a large variety of industrial plants. Moreover, the present teachings can enable a suitable model for the same purpose even if the scenarios such as processing or production type changes in the same industrial plant.

“Industrial plant” or “plant” may refer, without limitation, to any technical infrastructure that is used for an industrial purpose of manufacturing, producing or processing of one or more industrial products, i.e., a manufacturing or production process or a processing performed by the industrial plant. The industrial product can, for example, be any physical product, such as a chemical, a biological, a pharmaceutical, a food, a beverage, a textile, a metal, a plastic, a semiconductor. Additionally, or alternatively, the industrial product can even be a service product, for example, recovery or waste treatment such as recycling, chemical treatment such as breakdown or dissolution into one or more chemical products. Accordingly, the industrial plant may be one or more of a chemical plant, a process plant, a pharmaceutical plant, a fossil fuel processing facility such as an oil and/or a natural gas well, a refinery, a petrochemical plant, a cracking plant, and the like. The industrial plant can even be any of a distillery, a treatment plant, or a recycling plant. The industrial plant can even be a combination of any of the examples given above or their likes.

The infrastructure may comprise equipment or process units such as any one or more of a heat exchanger, a column such as a fractionating column, a furnace, a reaction chamber, a cracking unit, a storage tank, an extruder, a pelletizer, a precipitator, a blender, a mixer, a cutter, a curing tube, a vaporizer, a filter, a sieve, a pipeline, a stack, a filter, a valve, an actuator, a mill, a transformer, a conveying system, a circuit breaker, a machinery e.g., a heavy duty rotating equipment such as a turbine, a generator, a pulverizer, a compressor, an industrial fan, a pump, a transport element such as a conveyor system, a motor, etc.

Further, an industrial plant typically comprises a plurality of sensors and at least one control system for controlling at least one parameter related to the process, or process parameter, in the plant. Such control functions are usually performed by the control system or controller in response to at least one measurement signal from at least one of the sensors. The controller or control system of the plant may be implemented as a distributed control system (“DCS”) and/or a programmable logic controller (“PLC”).

Thus, at least some of the equipment or process units of the industrial plant may be monitored and/or controlled for producing one or more of the industrial products. The monitoring and/or controlling may even be done for optimizing the production of the one or more products. The equipment or process units may be monitored and/or controlled via a controller, such as DCS, in response to one or more signals from one or more sensors. In addition, the plant may even comprise at least one programmable logic controller (“PLC”) for controlling some of the processes. The industrial plant may typically comprise a plurality of sensors which may be distributed in the industrial plant for monitoring and/or controlling purposes. Such sensors may generate a large amount of data. The sensors may or may not be considered a part of the equipment. As such, production, such as chemical and/or service production, can be a data heavy environment. Accordingly, each industrial plant may produce a large amount of process related data.

Those skilled in the art will appreciate that the industrial plant usually may comprise instrumentation that can include different types of sensors. Sensors may be used for measuring one or more process parameters and/or for measuring equipment operating conditions or parameters related to the equipment or the process units. For example, sensors may be used for measuring a process parameter such as a flowrate within a pipeline, a level inside a tank, a temperature of a furnace, a chemical composition of a gas, etc., and some sensors can be used for measuring vibration of a pulverizer, a speed of a fan, an opening of a valve, a corrosion of a pipeline, a voltage across a transformer, etc. The difference between these sensors cannot only be based on the parameter that they sense, but it may even be the sensing principle that the respective sensor uses. Some examples of sensors based on the parameter that they sense may comprise: temperature sensors, pressure sensors, radiation sensors such as light sensors, flow sensors, vibration sensors, displacement sensors and chemical sensors, such as those for detecting a specific matter such as a gas. Examples of sensors that differ in terms of the sensing principle that they employ may for example be: piezoelectric sensors, piezoresistive sensors, thermocouples, impedance sensors such as capacitive sensors and resistive sensors, and so forth.

The industrial plant may even be part of a plurality of industrial plants. The term “plurality of industrial plants” as used herein is a broad term and is to be given its ordinary and customary meaning to a person of ordinary skill in the art and is not to be limited to a special or customized meaning. The term specifically may refer, without limitation, to a compound of at least two industrial plants having at least one common industrial purpose. Specifically, the plurality of industrial plants may comprise at least two, at least five, at least ten or even more industrial plants being physically and/or chemically coupled. The plurality of industrial plants may be coupled such that the industrial plants forming the plurality of industrial plants may share one or more of their value chains, educts and/or products. The plurality of industrial plants may also be referred to as a compound, a compound site, a Verbund or a Verbund site. Further, the value chain production of the plurality of industrial plants via various intermediate products to an end product may be decentralized in various locations, such as in various industrial plants, or integrated in the Verbund site or a chemical park. Such Verbund sites or chemical parks may be or may comprise one or more industrial plants, where products manufactured in the at least one industrial plant can serve as a feedstock for another industrial plant.

“Production process” refers to any industrial process which when, used on, or applied to an input material provides the chemical product. The chemical product is thus provided by transforming the input material either directly, or via one or more derivative materials, via the production process to result in the chemical product. The production process can thus be any manufacturing or treatment process or a combination of a plurality of processes that are used for obtaining the chemical product. The production process may even include packaging and/or stacking of the chemical product. The production process may thus be a combination of chemical and physical processes. Production process may even refer to processing of the input material to provide a processed material or product.

“Equipment” may refer to any one or more assets within the industrial plant. As non-limiting examples, the equipment may refer to any one or more, or any of their combination of, computing units or controllers such as programmable logic controller (“PLC”) or distributed control system (“DCS”), sensors, actuators, end effector units, transport elements such as conveyor systems, heat exchangers such as heaters, furnaces, cooling units, reactors, mixers, millers, choppers, compressors, slicers, extruders, dryers, sprayers, pressure or vacuum chambers, tubes, bins, silos and any other kind of apparatus which is used directly or indirectly for or during production in the industrial plant. Preferably, the equipment refers specifically to those assets, apparatuses or components which are involved directly or indirectly in processing or production process. More preferably, those assets, apparatuses or components which can influence the performance of the chemical product. An equipment may be buffered or they may be unbuffered. Moreover, the equipment may involve mixing or no mixing, separation or no separation. Some non-limiting examples of unbuffered equipment without mixing are, conveyor system or belt, extruder, pelletizer, and heat exchanger. Some non-limiting examples of buffered equipment without mixing are, buffer silo, bins, etc. Some non-limiting examples of buffered equipment with mixing are, silo with mixer, mixing vessel, cutting mill, double cone blender, curing tube, etc. Some non-limiting examples of unbuffered equipment with mixing are, static or dynamic mixer, etc. Some nonlimiting examples of buffered equipment with separation are, column, separator, extraction, thin film vaporizer, filter, sieve, etc. The equipment may even be or it may include a storage or packaging element such as, octabin filling, drum, bag, tank truck.

“Equipment operating conditions” refers to any characteristics or values that represent the state of the equipment, for example, any one or more of, setpoint, controller output, production sequence, calibration status, any equipment related warning, vibration measurement, speed, temperature, fouling value such as filter differential pressure, maintenance date, etc.

“Chemical product” in this disclosure may refer to any industrial product, such as chemical, pharmaceutical, nutritional, cosmetic, or biological product, or even any of their combination. The chemical product may be either consist entirely of natural components, or it may at least partially comprise one or more synthetic components. Some non-limiting examples of the chemical product are, organic or inorganic compositions, monomers, polymers, foams, pesticides, herbicides, fertilizers, feed, nutrition products, precursors, pharmaceuticats or treatment products, or any one or more of their components or active ingredients. In some cases, the chemical product may even be a product usable by an end-user or con-sumer, for example, a cosmetic or pharmaceutical composition. The chemical product may even be a product that is usable for making further one or more products. The chemical product may be in any form, for example, in the form of solid, semi-solid, paste, liquid, emulsion, solution, pellets, granules, beads, or particles.

“Parameter” in this context refers to any relevant physical or chemical characteristic and/or a measure thereof, such as temperature, direction, position, quantity, density, weight, color, moisture, speed, acceleration, rate of change, pressure, force, distance, pH, concentration and composition. The parameter may also refer to a presence or lack thereof of a certain characteristic.

“Process parameters” may refer to any of the processing or production process related variables, for example any one or more of, temperature, pressure, time, level, etc.

“Process data” refers to data comprising values, for example, numerical or binary signal values, measured during the processing or production process, for example, via the one or more sensors. The process data may be time-series data of one or more of the process parameters and/or equipment operating conditions. Preferably, the process data comprises temporal information of the process parameters and/or the equipment operating conditions, e.g., the data contains time stamps for at least some of the data points related to the process parameters and/or the equipment operating conditions.

“Equipment operating conditions” refers to any characteristics or values that represent the state of the equipment, for example, any one or more of, setpoint, controller output, production sequence, calibration status, any equipment related warning, vibration measurement, speed, temperature, fouling value such as filter differential pressure, maintenance date, etc.

“Real-time process data” refers to the process data that are measured or are in a transient state during the processing or production process. The real-time process data are hence those which are generated with little or no time delay. The term “real-time” is understood in the technical field of computers and instrumentation. As a specific non-limiting example, a time delay between a production occurrence during the processing or production process being performed on an input material and the process data being measured or read-out is less than 15 s, specifically of no more than 10 s, more specifically of no more than 5 s. For high throughput processing the delay is less than a second, or less than a couple of milliseconds, or even lower. The real-time data can thus be understood as a stream of time-dependent process data or time-series data being generated during the processing of the input material.

“Monitoring” refers to the observation and recording of any state of operation of the industrial plant. The state of operation includes internal parameters, such as those parameters which are solely relevant within the plant such as equipment temperature, pressure, electricity consumption, input or output material flows, rotational speeds of stirrers, states of valves, concentrations of vapors in the air within the industrial plant, number of people inside the plant. The state of operation also includes external parameters, such as parameters which relate to any exchange with the environment of the industrial plant, such as emission of chemical vapors, heat, sound, vibrations, light. Recording can mean storing the raw data onto a permanent data storage device or preparing documents in a format which are required by the company or by authorities.

“Controlling” refers to taking any actions to change the state of operation of the industrial plant. The actions can be direct, for example by changing the state of a valve, changing the temperature by additional heating or increasing the cooling. The actions can also be indirect, for example by prompting an operator to take actions, for example exchanging a filter or adjusting through-put.

When viewed from another perspective, there can also be provided a use of the at least one performance parameter generated according to any of the above method aspects for monitoring and/or controlling an industrial plant.

Thus, the at least one performance parameter generated via the trained plant level model can be used for monitoring and/or controlling the industrial in an open-loop or closed-loop manner. For example, a control system may be input with the at least one performance parameter. The input may be compared with respect to a set-point such that an output of the control system in dependent upon the comparison. The output can thus be used to manipulate the industrial plant in such a manner that the comparison is minimized. Additionally, or alternatively, the performance parameter may be provided to a human machine interface (“HMI”). A user can thus be enabled to monitor the performance parameter. The user can even be enabled to take a corrective action should the performance parameter drift from a desired value or range.

When viewed from another perspective, there can also be provided a use of the trained plant level model generated according to any of the above method aspects for modeling and/or monitoring and/or controlling an industrial plant.

Thus, the trained plant level model can be input with real-time data from the industrial plant such that the at least one performance parameter is generated. As explained above, the generated performance parameter may be usable for monitoring and/or controlling the industrial plant.

When viewed from another perspective, there can also be provided a framework or system for modeling and/or monitoring and/or controlling an industrial plant, wherein the system is configured to perform any of the methods herein disclosed. The modeling and/or monitoring and/or controlling may be performed via one or more computing units. The computing units may be operatively coupled to at least one memory storage.

For example, there can be provided a system for modeling and/or monitoring and/or controlling an industrial plant, the industrial plant comprising a plurality of equipment, the system being configured to:
provide, at a memory storage, a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtain, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

The system may comprise
a) an input for receiving the topology representation,
b) a processor for providing a plant level model of the industrial plant; wherein the plant level model has been generated via a topology generator by selecting and interconnecting equipment models from a model library, the model library comprising computer readable equipment models for at least some of the equipment, and the plant level model being a topology representation of the industrial plant, and for obtaining, using a model trainer, a trained plant level model; wherein the trained plant level model is obtained from the plant level model by training at least some of the equipment models in the plant level model using one or more historical datasets,
c) and an output to output the trained plant level model.

When viewed from another perspective, there can also be provided a computer program comprising instructions which, when the instructions are executed by any one or more suitable computing units, cause the computing units to carry out any of the methods herein disclosed.

There can also be provided a non-transitory computer readable medium storing a program causing any one or more suitable computing units to execute any method steps herein disclosed.

For example, there can be provided a computer program, or a non-transitory computer readable medium storing the program, comprising instructions which, when the instructions are executed by any one or more suitable computing units, cause the computing units to:
provide, at a memory storage, a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtain, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

There can also be provided a computer storage, or a non-transitory computer readable medium, storing the trained plant level model as generated according to any of the method aspects herein disclosed.

There can even be provided a computer storage, or a non-transitory computer readable medium, storing the trained plant level model as generated according to any of the method aspects herein disclosed which when executed is used for monitoring and/or controlling an industrial plant.

“Computing unit” may comprise, or it may be, a processing means or computer processor such as a microprocessor, microcontroller, or their like, having one or more processing cores. In some cases, the computing unit may at least partially be a part of the equipment, for example it may be a process controller such as programmable logic controller (“PLC”) or a distributed control system (“DCS”), and/or it may be at least partially be a remote server. Accordingly, the computing unit may receive one or more input signals from one or more sensors operatively connected to the equipment. If the computing unit is not a part of the equipment, it may receive one or more input signals from the equipment. Alternatively, or in addition, the computing unit may control one or more actuators or switches operatively coupled to the equipment. The one or more actuators or switches operatively may even be a part of the equipment.

Accordingly, the computing unit may be able to manipulate one or more parameters related to the production process by controlling any one or more of the equipment.

“Computer processor” refers to an arbitrary logic circuitry configured for performing basic operations of a computer or system, and/or, generally, to a device which is configured for performing calculations or logic operations. In particular, the processing means or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means or computer processor may be a multicore processor. Specifically, the processing means or computer processor may be or may comprise a Central Processing Unit (“CPU”). The processing means or computer processor may be a (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

“Interface” may be a hardware and/or a software component, either at least partially a part of the equipment, or a part of another computing unit, e.g., via which the object identifier is provided. For example, the interface may be an application programming interface (“API”). In some cases, the interface may also connect to at least one network, for example, for interfacing two pieces of hardware components and/or protocol layers in the network. For example, the interface may be an interface between the equipment and the computing unit. In some cases, the equipment may be communicatively coupled to the computing unit via the network. Thus, the interface may even be a network interface, or it may comprise the network interface. In some cases, the interface may even be a connectivity interface, or it may comprise the connectivity interface.

“Memory storage” may refer to a device for storage of information, in the form of data, in a suitable storage medium. Preferably, the memory storage is a digital storage suitable for storing the information in a digital form which is machine-readable, for example digital data that are readable via a computer processor. The memory storage may thus be realized as a digital memory storage device that is readable by a computer processor. Further preferably, the memory storage on the digital memory storage device may also be manipulated via a computer processor. For example, any part of the data recorded on the digital memory storage device may be written and/or erased and/or overwritten, partially or wholly, with new data by the computer processor.

“Network” discussed herein may be any suitable kind of data transmission medium, wired, wireless, or their combination. A specific kind of network is not limiting to the scope or generality of the present teachings. The network can hence refer to any suitable arbitrary interconnection between at least one communication endpoint to another communication endpoint. Network may comprise one or more distribution points, routers or other types of communication hardware. The interconnection of the network may be formed by means of physically hard wiring, optical and/or wireless radio-frequency methods. The network specifically may be or may comprise a physical network fully or partially made by hardwiring, such as a fiber-optical network or a network fully or partially made by electrically conductive cables or a combination thereof. The network may at least partially comprise the internet.

“Network interface” refers to a device or a group of one or more hardware and/or software components that allow an operative connection with the network.

“Remote server” refers to one or more computers or one or more computer servers that are located away from the plant. The remote server may thus be located several kilometers or more from the plant. The remote server may even be located in a different country. The remote server may even be at least partially implemented as a cloud service or platform, for example as platform as a service (“PaaS”). The term may even refer collectively to more than one computer or server located on different locations. The remote server may be a data management system.

A computer-readable data medium or carrier includes any suitable data storage device on which is stored one or more sets of instructions (e.g., software) embodying any one or more of the methodologies or functions described herein. The instructions may also reside, completely or at least partially, within the main memory and/or within the processor during execution thereof by the computing unit, main memory, and processing device, which may constitute computer-readable storage media. The instructions may further be transmitted or received over a network via a network interface device.

The computer program for implementing one or more of the embodiments described herein may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network.

Furthermore, a data carrier or a data storage medium for making a computer program product available for downloading can be also provided, which computer program product is arranged to perform a method according to any of the aspects herein disclosed.

When viewed from another perspective, there can also be provided a computing unit comprising the computer program code for carrying out the method herein disclosed. Also, there can be provided a computing unit operatively coupled to a memory storage comprising the computer program code for carrying out the method herein disclosed.

That two or more components are “operatively” coupled or connected shall be clear to those skilled in the art. In a non-limiting manner, this means that there may at least be a communicative connection between the coupled or connected components e.g., via the interface or any other suitable interface. The communicative connection may either be fixed or it may be removable. Moreover, the communicative connection may either be unidirectional, or it may be bidirectional. Furthermore, the communicative connection may be wired and/or wireless. In some cases, the communicative connection may also be used for providing control signals.

### BRIEF DESCRIPTION OF THE SEVERAL VIEWS OF THE DRAWINGS

Certain aspects of the present teachings will now be discussed with reference to the following drawings that explain the said aspects by the way of examples. Since the generality of the present teachings is not dependent on it, the drawings may not be to scale. Certain features shown in the drawings can be logical features that are shown together with physical features for sake of understanding and without affecting the generality of the present teachings.

FIG. 1 illustrates an aspect of the present teachings.

FIG. 2 illustrates a flowchart for a method aspect of the present teachings.

FIG. 3 illustrates a logical representation showing certain aspects of the present teachings.

### DETAILED DESCRIPTION

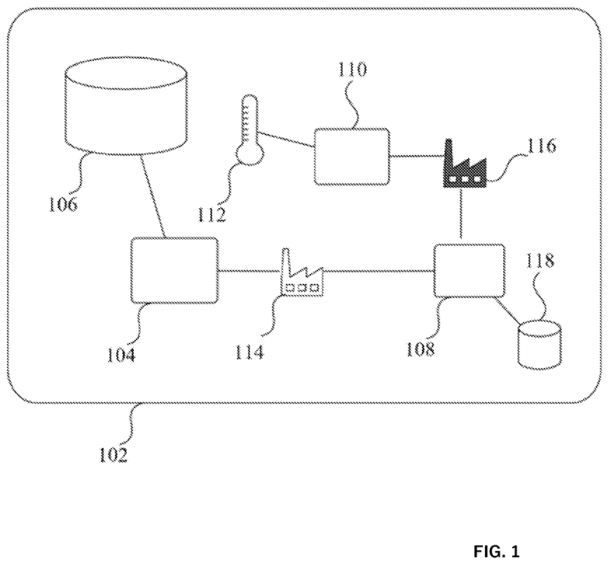

FIG. 1 shows a framework 102 pursuant to an aspect of the present teachings. The framework 102 can be used for modeling and/or monitoring and/or controlling an industrial plant.

The industrial plant may comprise a plurality of equipment for processing or manufacturing one or more chemical products.

The framework may comprise one or more computing units and at least one memory storage 106. The framework 102 can be configured such that it is provided, a plant level model 114 of the industrial plant. The plant level model 114 is generated via a topology generator 104 by automatically selecting and interconnecting equipment models from a model library that may be located at the memory storage 106. According to a preferable aspect, at least some the equipment models are interconnected via at least one effect model. The plant level model 114 may even be provided at the memory storage 106 or at another memory or database. The model library comprises computer readable equipment models for at least some of the equipment. The plant level model 114 being a topology representation of the industrial plant, for example as configured to process or produce the chemical product.

Via a model trainer 108, a trained plant level model 116 is obtained. The trained plant level model 116 is related to the plant level model 114 by training at least some of the equipment models in the plant level model 114 using one or more historical datasets. The historical datasets may be stored at a historical dataset database 118. The historical dataset database 118 may even be a part of the memory storage 106.

The trained plant level model 116 is usable for computing at least one performance parameter 112 via a model executor 110. The at least one performance parameter 112 is related to the industrial plant. Pursuant to the present teachings, the framework 102 can allow building and deployment of the trained plant level model 116 according to the relevant processing or production scenario at the industrial plant. Moreover, in a plurality of industrial plants, the framework 102 can allow reusability of the models even between industrial plants at different locations. This can not only simplify the computation of the at least one performance parameter 112, but also at least partially alleviate the need for an expert user to build and deploy a trained plant level model 116 which is suitable for a given industrial plant or process.

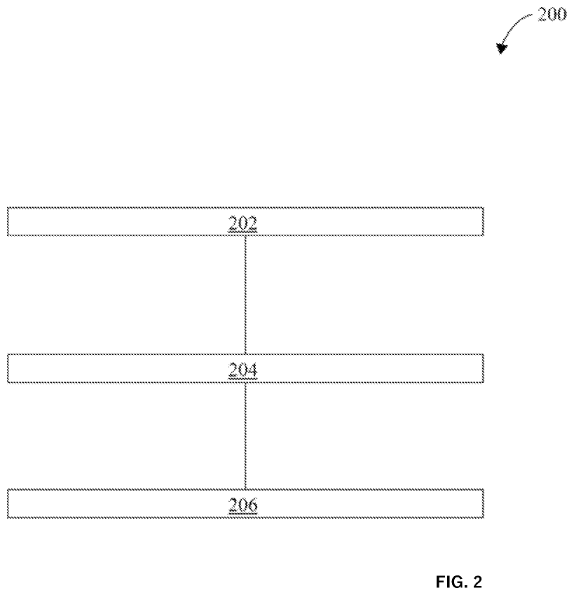

FIG. 2 shows a flowchart 200 or routine illustrating a method aspect of the present teachings. In block 202, it is provided a plant level model 114 of the industrial plant. The plant level model has been generated via a topology generator 104 by automatically selecting and interconnecting equipment models from a model library. In block 204, it is obtained, using a model trainer 108, a trained plant level model 116. The trained plant level model 116 is obtained from the plant level model 114 by training at least some of the equipment models in the plant level model 114 using one or more historical datasets. The trained plant level model 116 is usable for computing at least one performance parameter 112 via a model executor 110. Optionally, in block 206, it is computed, via the model executor 110, the at least one performance parameter 112 using the trained plant level model 116.

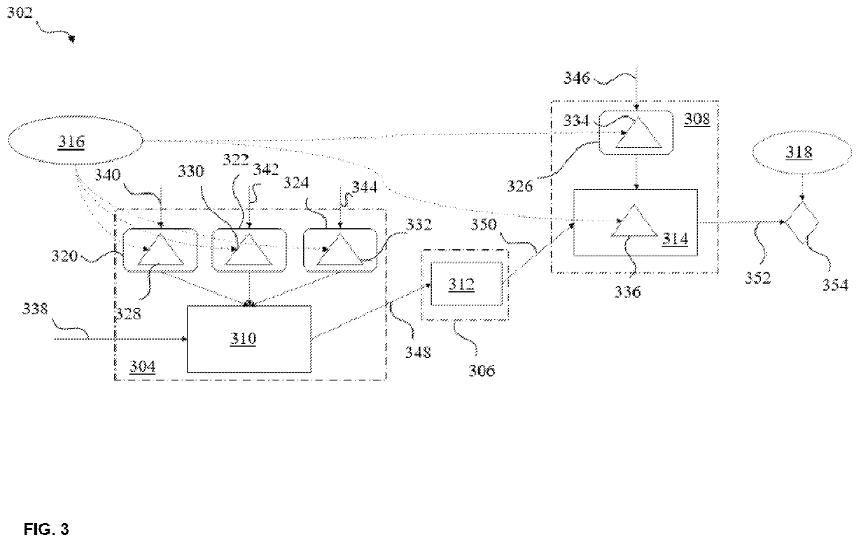

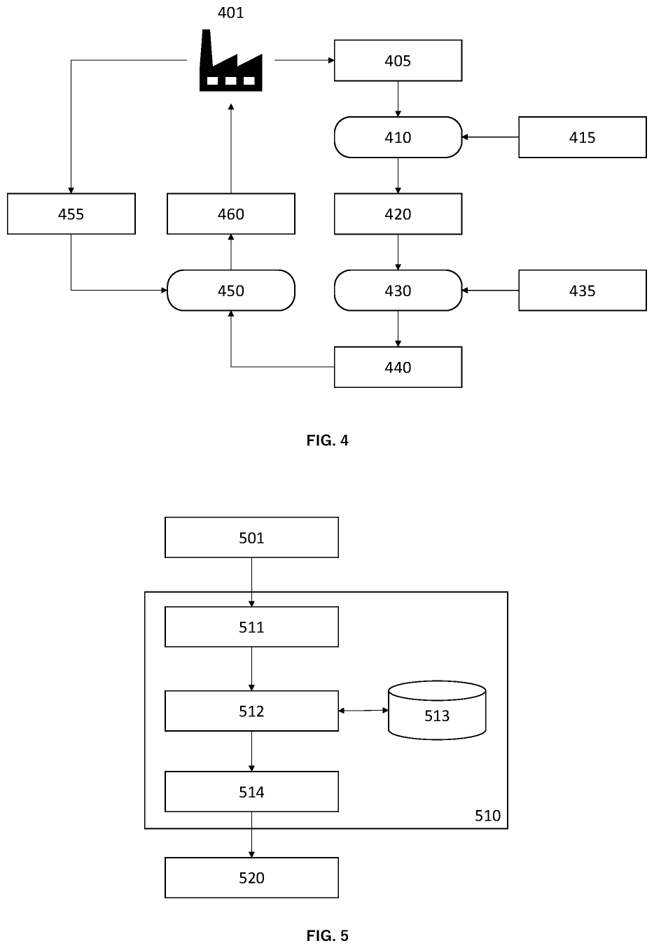

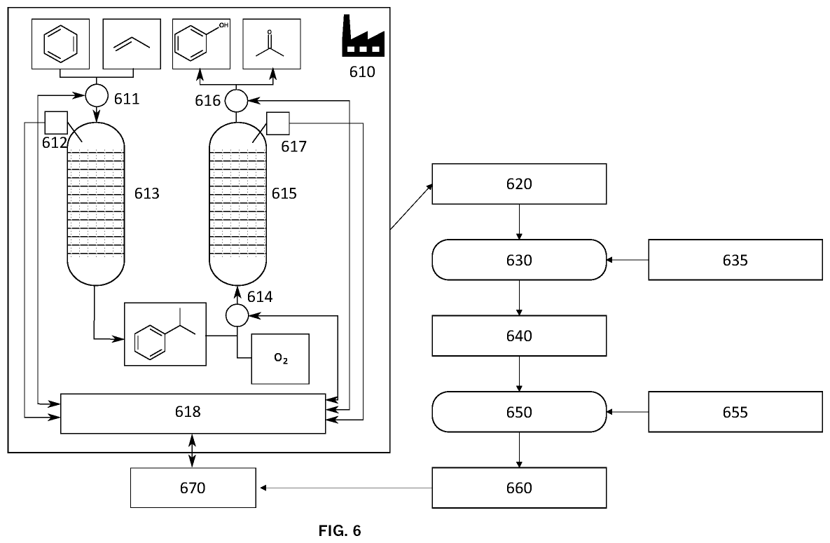

FIG. 3 shows a logical representation 302 of certain aspects of the present teachings. A trained plant level model 116 is shown comprising computer-readable models, i.e., a first model 304 and second model 306 and a third model 308 which in this example are interconnected via a first model output 348 that connects the first model 304 to the second model 306, and a second model output 350 that connects the second model 306 to the third model 308. The first model 304, the second model 306 and the third model 308 are automatically selected from the model library and interconnected via the topology generator 104.

The computer-readable models may either be equipment models or at least some of them may be equipment models that include one or more effect models or effect model parts.

In this example, the first model 304 comprises a first equipment model part 310, a first effect model part 320, a second effect model part 322 and a third effect model part 324. As input, the first equipment model part 310 is provided a first model input 338 and inputs from each of the first effect model part 320, the second effect model part 322 and the third effect model part 324. The first equipment model part 310 provides a first model output 348, which is also the output of the first model 304. At the first model 304 level, inputs include a second model input 340, a third model input 342 and a fourth model input 344, which internally in the first model 304 are provided to the first effect model part 320, the second effect model part 322 and the third effect model part 324 respectively. Thus, the first model 304 has four inputs and one output. It can be seen that the first effect model part 320, the second effect model part 322 and the third effect model part 324 and provided with a first trainable part 328, a second trainable part 330, and a third trainable part 332 respectively. These models are hence trainable models, for example, data-driven models. As can be seen, the trainable parts are trained using historical data 316. The respective trainable parts comprise trainable parameters which are set or trained using one or more historical datasets from the historical data 316. Thus, values of said trainable parameters are set via the historical data 316. Any of the data-driven models may either be pure black-box models, or they may be grey-box models.

The output from the first model 304, or the first model output 348 is shown feeding to the second model 306. The second model 306 is shown as having only a second equipment model 312 that is provided the first model output 348 as a sole input, and it provides the second model output 350 as a sole output. It can be seen that the first equipment model part 310 and the second equipment model 312 do not have trainable parts. These models may be mechanistic models, for example ordinary differential equation (“ODE”) models.

The output from the second model 306, or the second model output 350 is shown feeding to the third model 308. Thus, the third model 308 receives, as one of its inputs, the second model output 350 which is shown provided to a third equipment model part 314 which is a part of the third model 308. The third model 308 also includes a fourth effect model part 326 which is provided a fifth model input 346. The output of the fourth effect model part 326 feeds to the third equipment model part 314. As can be seen, both the third equipment model part 314 and the fourth effect model part 326 are trainable models as each of these are provided with a fourth trainable part 334 and a fifth trainable part 336 respectively. As explained earlier, the trainable parts are trained using the historical data 316. The training is done via the model trainer. Hence, the trained plant level model 116 is obtained by training, via the model trainer, the plant level model 114. In other words, by training the first trainable part 328, the second trainable part 330, the third trainable part 332, the fourth trainable part 334 and the fifth trainable part 336 using the historical data 316. The third model 308 provides a model output 352 which in this case is shown as a global output of the trained plant level model 116. It shall be appreciated that the trained plant level model 116 may even have a plurality of outputs. The model output 352 may thus provide computed or predicted value of at least one performance parameter. The computation may be done via a model executor logic. The model executor may deploy the trained plant level model 116, for example, by providing respective relevant parts of real-time data 318 at the respective model inputs, i.e., the first model input 338, the second model input 340, the third model input 342, the fourth model input 344, and the fifth model input 346.

The model executor may even comprise a model monitoring logic 354 which monitors performance of the trained plant level model 116 based on one or more metrics. The monitoring logic 354 may use the real-time data 318 or a part thereof for monitoring the performance. Model monitoring logic 354 can thus trigger re-training of the plant level model 114 to result in a new trained plant level model 116, or it may result in the decommissioning of the trained plant level model 116. This can improve reliability of the model and thus prevent incorrect logic to be applied for monitoring and/or controlling the industrial plant.

It will be appreciated that the real-time data 318 refers to real-time process data, e.g., the data that are generated during the plant operation.

Those skilled in the art shall appreciate that any specific model structure shown in this example is not limiting to the scope or generality of the present teachings. For example, in case of the first model 304, from input to output, effect models are shown preceding the first equipment model part 310. However, in some cases it may be the other way round. In some cases, dependent upon model complexity and abstraction level, even nested model structures with parallel and/or series combinations with multiple models in each signal path may be realized. Furthermore, a model output may or may not be provided directly via an equipment model part. In other words, any model output may even be provided via an effect model part. Any model may have one or more inputs and one or more outputs.

As a non-limiting example, the first model 304 could represent a catalytic reactor which includes: a reactor model part in the form of the first equipment model part 310, and a plurality of effect model parts 320, 322 and 324. The effect model parts 320, 322 and 324 may represent various kinds of deactivation mechanisms and/or extraneous effects such as deactivation of catalyst over time and/or in dependence to various process parameters, leakages, non-idealities and so forth. In this example, the output 348 of the catalytic reactor model 304 is provided into a pump model represented as the second model 306. The pump is modeled using a single equipment model, i.e., the second equipment model 312. The pump model output 350 from the pump model 312 is provided to a distillation column represented as the third model 308. The distillation column model 308 has a distillation column equipment model part 314 and a single effect part represented with the fourth effect model part 326. The fourth effect model part 326 here could be a data-driven model which corrects the output of the distillation column model 308 without explicitly modeling any chemical process. When executed, one or more model performance parameters are provided via the output 352 of the distillation column model 308. The inputs to the models namely, 338, 340, 342, 344, 346 may be external inputs via which process parameters are provided to the trained model 302 when it is deployed. The process parameters are provided as or from at least a part of the real-time data 318.

In this specific example, the distillation column model 308 along with the effect models 320, 322, 324 and 326 have trainable parts or parameters which are set or trained using one or more historical datasets. This is done via the model trainer. The model performance parameter that is provided via the model output 352 could be yield which could be monitored using the monitoring logic in 354. The monitoring logic 354 may use real-time data 318 or a part thereof for monitoring the model. The monitoring logic 354 may compute one or more scoring metrics for monitoring the model performance of the trained model 302. The monitoring happens usually after the model is deployed. Any substantial change, or a deviation of any one or more of the scoring metrics beyond a respective threshold may prompt either retraining of the model via the model trainer, or it is used for decommissioning the model 302.

FIG. 4 shows an example of how the method can be used to monitor or control an industrial plant. A topology representation 405 is received from the industrial plant 401. The topology generator 410 receives the topology representation 405 and generates a plant level model 420. For this purpose, the topology generator 410 uses the information of the topology representation containing the equipment of the industrial plant and looks for closely fitting models in a model library 415. The resulting plant level model 420 hence contains the models from the model library 415 according to the topology representation 405. The plant level model 420 is then trained by a model trainer 430. For this purpose, the model trainer 430 uses historic data 435 and adjusts parameters in the plant level model 420 in a way that the plant level model 420 most closely fits the historic data. As a result, the model trainer outputs a trained plant level model 440. The trained plant level model 440 can be used by a model executer 450. The model executer 450 receives from the industrial plant sensor data 455, feeds them into the trained plant level model 440 to obtain one or more performance parameters 460. Such performance parameters 460 can be passed to the industrial plant 401 where the performance parameters 460 are used to monitor the process in the industrial plant 401 and/or to control it, for example by adjusting settings of equipment.

FIG. 5 shows an example for a system usable for the method of the present invention. The system 510 contains an input 511 to receive a topology representation 501. The system 510 further contains a processor 512 and a database 513. The processor 512 is adapted to receive based on the topology representation 501 models from a model library stored in the database 513 and generated a plant level model therefrom. The processor 512 is further adapted to receive historic data from the database 513 to train the plant level model and thereby generating a trained plant level model 520. The system 510 further contains an output 514 for outputting the trained plant level model 520 which can then be used to monitor and/or control an industrial plant.

FIG. 6 shows an exemplary embodiment. The industrial plant 610 is a chemical plant producing phenol and acetone out of benzene and propene in two solid-state reactors 613, 615, wherein in the first reactor 613 benzene and propene are reacted to yield cumene which is converted in reactor 615 into phenol and acetone by using oxygen. The topology model 620 hence contains the information that two solid state reactor columns are used in series, i.e. the product of the first reactor is used as input for the second reactor. It may further contain the information, that the first reactor 613 is equipped with a temperature and pressure sensor 612 and that the second reactor 615 is equipped with a temperature and pressure sensor 617. The topology generator 630 receives the topology model 620 and searches in the model library 635 for models for a solid-state reactor. The topology generator 630 combines these models according to their connectivity in the topology model 620 into a plant level model 640. Model trainer 650 receives historic data and uses these to train the plant level model 650 to yield the trained plant level model 660. The trained plant level model 660 is passed to a model executor 670, which may run on a computer system which stands in communication with the distributed control system 618 of the industrial plant 610. The distributed control system 618 receives sensor data from the sensors 612, 617, forwards these to the model executor 670 which uses the sensor data as input for the trained plant level model 660 yielding the performance parameter, for example the catalytic activity in reactors 613, 615. The distributed control system 618 may control the industrial plant 610 by adjusting the settings of any of the valves 611, 614, 616. It may also generate a message to inform the plant operator about a catalyst exchange when a certain value is reached.

The method steps may be performed, for example, in the order as shown listed in the examples or aspects. It shall be noted, however, that, under specific circumstances, a different order may also be possible. Further, it is also possible to perform one or more of the method steps once or repeatedly. The steps may be repeated at regular or irregular time periods. Further, it is possible to perform two or more of the method steps simultaneously or in a timely overlapping fashion, specifically when some or more of the method steps are performed repeatedly. The method may comprise further steps which are not listed.

The word “comprising” does not exclude other elements or steps, and the indefinite article “a” or “an” does not exclude a plurality. A single processing means, processor or controller or other similar unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

Further, it shall be noted that in the present disclosure, the terms “at least one”, “one or more” or similar expressions indicating that a feature or element may be present once or more than once typically may have been used only once when introducing the respective feature or element. Thus, in some cases unless specifically stated otherwise, when referring to the respective feature or element, the expressions “at least one” or “one or more” may not have been repeated, non-withstanding the fact that the respective feature or element may be present once or more than once.

Further, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The present teachings may, as the skilled person will recognize, be performed by using alternative features. Similarly, features introduced by “according to an aspect” or similar expressions are intended to be optional features, without any restriction regarding alternatives of the present teachings, without any restrictions regarding the scope of the present teachings and without any restriction regarding the possibility of combining the features introduced in such way with other optional or non-optional features of the present teachings.

Any headings utilized within the description are for convenience only, accordingly such headlines do not have any limiting or restrictive effect on the subject matter.

Various examples have been disclosed above including, a method for modeling an industrial plant; a framework or system for modeling an industrial plant; a use of the at least performance parameter; a use of the trained plant level model; a software program; a storage medium; and a computing unit comprising the computer program code for carrying out the method herein disclosed. Those skilled in the art will understand however that changes and modifications may be made to those examples without departing from the spirit and scope of the accompanying claims and their equivalents. It will further be appreciated that aspects from the method and product embodiments discussed herein may be freely combined.

For example, the present teachings relate to a method for modeling an industrial plant comprising a plurality of equipment, the method comprising:
providing a plant level model of the industrial plant; wherein the plant level model has been generated via a topology generator by automatically selecting and interconnecting equipment models from a model library,
obtaining, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor. The present teachings also relate to a framework, a software product, a use of the model and a use of the performance parameter.

Summarizing and without excluding further possible embodiments, certain example embodiments of the present teachings are summarized in the following clauses:

Clause 1. A computer-implemented method for modeling an industrial plant, said industrial plant comprising a plurality of equipment, wherein the method comprises:
providing a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtaining, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

Clause 2. The computer-implemented method of clause 1, wherein the method also comprises:
computing, via the model executor, the at least one performance parameter using the trained plant level model.

Clause 3. A computer-implemented method for computing at least one performance parameter related to an industrial plant, said industrial plant comprising a plurality of equipment, wherein the method comprises:
providing a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtaining, using a model trainer, a trained plant level model; wherein the trained plant level model is obtained from the plant level model by training at least some of the equipment models in the plant level model using one or more historical datasets;
computing, via a model executor, at least one performance parameters using the trained plant level model.

Clause 4. A computer-implemented method for computing at least one performance parameter related to an industrial plant, said industrial plant comprising a plurality of equipment, wherein the method comprises:
providing a model library comprising computer readable equipment models for at least some of the equipment;
generating, via a topology generator, a plant level model of the industrial plant by selecting and interconnecting equipment models from the model library; the plant level model being a topology representation of the industrial plant;
training, via a model trainer, at least some of the equipment models in the plant level model; wherein the training is performed using one or more historical datasets,
computing, via a model executor, the at least one performance parameter using the trained plant level model.

Clause 5. A method of any of the above clause 1-clause 4, wherein the method comprises:
monitoring, via a monitoring logic, performance of the trained plant level model.

Clause 6. The method of any of the above clause 1-clause 5, wherein the model library also comprises at least one effect model describing one or more effects related to the industrial plant.

Clause 7. The method of clause 6, wherein the generation of the plant level model also includes the topology generator automatically selecting at least one effect model from the model library

Clause 8. The method of clause 7, wherein at least some of the equipment models are interconnected via one or more effect models.

Clause 9. The method of any of the above clause 1-clause 8, wherein at least one of the models is at least partly a mechanistic model.

Clause 10. The method of any of the above clause 1-clause 9, wherein at least one of the models is at least partly a data-driven model.

Clause 11. The method of any of the above clause 1-clause 10, wherein at least some of the models are also provided with task metadata.

Clause 12. The method of clause 11, wherein the topology generator uses the task metadata of a model for selecting the model.

Clause 13. The method of any of the above clause 1-clause 12, wherein the topology generator uses one or more keywords provided via a user input for selecting at least one of the models.

Clause 14. The method of any of the above clause 1-clause 13, wherein the topology generator uses a similarity score for selecting at least one of the models.

Clause 15. Use of the at least one performance parameter generated as in any of the above method clauses for monitoring and/or controlling an industrial plant.

Clause 16. Use of the trained plant level model generated according to any of the above method clauses for modeling and/or monitoring and/or controlling an industrial plant.

Clause 17. A framework for modeling and/or monitoring and/or controlling an industrial plant, wherein the framework is configured to perform any of the above method clauses.

Clause 18. A computer program, or a non-transitory computer readable medium storing the program, comprising instructions which, when the instructions are executed by any one or more suitable computing units, cause the computing units to carry out any of the steps of any of the above method clauses.

Clause 19. A computer storage medium, or a non-transitory computer readable medium, storing the trained plant level model as generated according to any of the above method clauses.

Clause 20. A computer storage medium, or a non-transitory computer readable medium, storing the trained plant level model generated according to any of the above method clauses, which when executed is used for monitoring and/or controlling an industrial plant.

Clause 21. A framework for modeling and/or monitoring and/or controlling an industrial plant, the industrial plant comprising a plurality of equipment, the framework being configured to:
provide, at a memory storage, a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtain, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

Clause 22. A computer program, or a non-transitory computer readable medium storing the program, comprising instructions which, when the instructions are executed by any one or more suitable computing units, cause the computing units to:
provide, at a memory storage, a plant level model of the industrial plant; wherein the plant level model has been generated via a topology generator by automatically selecting and interconnecting equipment models from a model library, the model library comprising computer readable equipment models for at least some of the equipment, and the plant level model being a topology representation of the industrial plant,
obtain, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

1. A computer-implemented method for providing a model for monitoring and/or controlling an industrial plant, said industrial plant comprising a plurality of equipment, wherein the method comprises:
providing a plant level model of the industrial plant; wherein the plant level model has been generated via a topology generator by selecting and interconnecting equipment models from a model library, the model library comprising computer readable equipment models for at least some of the equipment, and the plant level model being a topology representation of the industrial plant,
obtaining, using a model trainer, a trained plant level model; wherein the trained plant level model is obtained from the plant level model by training at least some of the equipment models in the plant level model using one or more historical datasets;
wherein the trained plant level model is usable for computing at least one performance parameter via a model executor, the at least one performance parameter being related to the industrial plant.

2. The method of claim 1, wherein the topology generator uses a similarity score for selecting at least one of the models.

3. The method of claim 1, wherein the similarity score is determined based on meta data associated with the models from the model library.

4. The method of claim 3, wherein the metadata contains the type of equipment, the process or the reagents or products the model relates to.

5. The method of claim 3, wherein the metadata is structured by an ontology.

6. The method of claim 1, wherein the method further comprises:
computing, via the model executor, the at least one performance parameter using the trained plant level model.

7. The method of claim 1, wherein the method further comprises:
monitoring, via a monitoring logic, performance of the trained plant level model.

8. The method of claim 1, wherein the model library further comprises at least one effect model describing one or more effects related to the industrial plant, wherein an effect model refers to a model for one or more physiochemical effects or processes.

9. The method of claim 8, wherein the generation of the plant level model further comprises the topology generator selecting at least one effect model from the model library.

10. The method of claim 9, wherein at least some of the equipment models are interconnected via one or more effect models.

11. The method of claim 1, wherein the topology generator uses one or more keywords provided via a user input for selecting at least one of the models.

12. A method for modeling and/or monitoring and/or controlling an industrial plant comprising using the trained plant level model generated according to claim 1.

13. A system for providing a model for monitoring and/or controlling an industrial plant, wherein the system is configured to perform the method of claim 1.

14. A computer program, or a non-transitory computer readable medium storing the program, comprising instructions which, when the instructions are executed by any one or more suitable computing units, cause the computing units to carry out any of the steps of the method of claim 1.

15. A computer storage medium, or a non-transitory computer readable medium, storing the trained plant level model as generated according to the method of claim 1.

16. The method of claim 4, wherein the metadata is structured by an ontology.
